(19) United States
(12) Patent Application Publication
(10) Pub. No.: US 2009/0068957 A1
(43) Pub. Date: Mar. 12, 2009

(54) RFID READER COMPENSATING LEAKAGE SIGNAL AND COMPENSATING METHOD THEREOF

(76) Inventors: JI-HUN KOO, Yongin-si (KR); Il-Jong Song, Yongin-si (KR); Si-Gyoung Koo, Seoul (KR); Young-Hoon Min, Anyang-si (KR); Kuang-Woo Nam, Suwon-si (KR); Yuri Tikhov, Suwon-si (KR); In-Hyuk Kim, Seoul (KR)

Correspondence Address: F. CHAU & ASSOCIATES, LLC, 130 WOODBURY ROAD, WOODBURY, NY, 11797, US

(21) Appl. No.: 12/205,401

(22) Filed: Sep. 5, 2008

(30) Foreign Application Priority Data
Sep. 7, 2007 (KR) 10-2007-0091038
Dec. 14, 2007 (KR) 10-2007-130838

(51) Int. Cl. H04B 17/00

(52) U.S. Cl. 455/67.14; 340/10.1

(57) ABSTRACT

A radio frequency identification (RFID) reader includes a transmitter generating a transmission signal for transmission to a tag, a receiver receiving a response signal from the tag, a leakage compensator compensating a leakage signal leaked from the transmitter to the receiver in response to a leakage control signal, and a control unit performing a leakage test operation by applying a test signal to the transmitter, and calculating and storing a leakage parameter for generating the leakage control signal using a level difference of the test signal and a level difference of a test leakage signal leaked to the receiver.

### CROSS-REFERENCE TO RELATED APPLICATIONS

This U.S. non-provisional patent application claims priority under 35 U.S.C. §119 to Korean Patent Application Nos. 10-2007-0091038, filed on Sep. 7, 2007, and 10-2007-130838, filed on Dec. 14, 2007, the disclosures of which are hereby incorporated by reference herein.

### BACKGROUND OF THE INVENTION

The present disclosure relates to a radio frequency identification reader (RFID reader), and more particularly, to an RFID reader compensating a transmission leakage signal.

A radio frequency identifier (RFID) is a contactless identification system exchanging data between an RFID reader and an RFID tag. The RFID reader alternatively transmits a modulation wave and a continuous wave toward the RFID tag. The modulation wave is a signal for transmitting data to the RFID tag from the RFID reader, and the continuous wave is a signal for receiving a response signal from the RFID tag.

When the RFID reader transmits the modulation wave, the RFID tag receives data transferred via the modulation wave. When the RFID reader transmits the continuous wave, the RFID tag modulates a amplitude of the continuous wave to generate the response signal. The response signal is transferred to the RFID reader. A two-way communication is classified into a half-duplex communication and a full-duplex communication. In the half-duplex communication, while one communication device performs a transmitting operation, another communication device can perform a receiving operation, however is inhibited to perform a transmitting operation. In the full-duplex communication, however, while one communication device performs a transmitting operation, another communication device can perform receiving and transmitting operations simultaneously.

In an RFID system, a data transmission from the RFID reader to the RFID tag and a data transmission from the RFID tag to the RFID reader are not simultaneously performed. The operation of transmitting the modulation wave to the RFID tag and the operation of transmitting the response signal to the RFID reader are separately performed because there is a time difference therebetween. That is, the RFID system employs a half-duplex communication method. However, the RFID reader transmits the continuous wave toward the RFID tag while the RFID tag transmits the response signal toward the RFID reader. That is, the RFID reader and the RFID tag simultaneously transmit radio waves toward each other, and thus the RFID system shares some similarities with the full-duplex communication method.

A full-duplex communication system distinguishes a transmission signal and a reception signal by making frequencies of the transmission signal and the reception signal different from each other. In an RFID system, the frequency of the continuous wave transmitted from the RFID reader is equal to the frequency of the response signal transmitted from the RFID tag. That is, when a transmission leakage occurs in a transmitter of the RFID reader, it can be received by a receiver of the RFID reader, and the two signals having the same frequency can be mixed and transferred to a controller in the RFID reader through the receiver. The controller processes data in the response signal according to a mixed signal including the leakage signal and the response signal, leading potentially to an error in determining the response signal. Consequently, the transmission leakage signal introduced into the receiver causes the performance of the RFID system to be degraded.

The RFID reader may employ one or two antennas to transmit or receive data. The RFID reader employing one antenna isolates the transmission signal and the reception signal by the use of a directional coupler. The directional coupler transfers a signal transmitted from the transmitter to the antenna, and prevents the signal transmitted from the transmitter from being transferred to the receiver. Also, the directional coupler transfers a signal transmitted from the antenna to the receiver, and prevents the signal transferred from the antenna from being transferred to the transmitter. However, a transmission/reception isolation of the directional coupler is not perfect. Accordingly, a portion of the transmission signal is leaked toward the receiver through the directional coupler.

In the RFID reader employing two antennas, a transmission signal output from a transmitting antenna, may be leaked to the receiver through a receiving antenna. Accordingly, since a distance between the transmitting and receiving antennas decreases as the RFID reader shrinks in size, a leakage signal transferred to the receiver increases.

### SUMMARY OF THE INVENTION

Embodiments of the present invention seek to provide a radio frequency identification (RFID) reader for compensating a transmission leakage signal leaked to a receiver, and a method for compensating the transmission leakage.

According to an exemplary embodiment of the present invention a radio frequency identification (RFID) reader includes a transmitter generating a transmission signal for transmission to a tag; a receiver receiving a response signal from the tag; a leakage compensator compensating a leakage signal leaked from the transmitter to the receiver in response to a leakage control signal; and a control unit performing a leakage test operation by applying a test signal to the transmitter, and calculating and storing a leakage parameter for generating the leakage control signal using a level difference of the test signal and a level difference of a test leakage signal leaked to the receiver.

The leakage parameter may be stored in a register of the control unit. The test signal may be a square wave in which one cycle has a high-level section and a low-level section, the high-level section being higher than a reference level, and the low-level section being lower than the reference level. The test signal may include a plurality of cycles. The control unit may calculate the leakage parameter using a mean value of a level difference of each cycle of the test leakage signal and a mean value of a level difference of each cycle of the test signal.

The transmitter and the receiver may be connected to a common antenna through a directional coupler. Alternatively, the transmitter may include a transmitting antenna, and the receiver may include a receiving antenna.

The leakage compensator may change an amplitude and a phase of the transmission signal, and may compensate the leakage signal using the changed transmission signal. The leakage parameter may include an amplitude ratio between the transmission signal and the leakage signal, and a phase difference between the transmission signal and the leakage signal. The leakage compensator may further include a variable amplitude controller controlling an amplitude of the transmission signal, and a variable phase shifter phase-shifting a phase of the transmission signal.

According to an exemplary embodiment of the present invention, a method of compensating a leakage signal of an RFID reader including a transmitter generating a transmission signal for transmission to a tag, a receiver receiving a response signal from the tag, and a leakage compensator compensating a leakage signal leaked from the transmitter to the receiver, the method including applying a test signal to the transmitter, and calculating and storing a leakage parameter using a level difference of the test signal and a level difference of a test leakage signal leaked to the receiver; and compensating the leakage signal using the leakage parameter.

According to an exemplary embodiment of the present invention, a method of compensating a leakage signal of an RFID reader including a transmitter selecting one of a plurality of channels, and transmitting a transmission signal to a tag through an antenna using the selected channel; a receiver receiving a response signal corresponding to the transmission signal from the tag; a leakage compensator responding to a leakage control signal to compensate the leakage signal reflected from the antenna and leaked to the receiver, the method includes applying a test signal corresponding to a frequency of each of the plurality of channels to the antenna, receiving a test leakage signal reflected from the antenna, measuring a return loss using the test signal and the test leakage signal, and calculating and storing leakage parameters corresponding to each of the plurality of channels using the return loss; and generating the leakage control signal using the leakage parameters.

The leakage parameters may be stored in a register.

The generating of the leakage control signal may include transmitting the transmission signal using the selected channel; receiving the response signal from the tag; and generating the leakage control signal using the leakage parameter corresponding to the selected channel.

The RFID reader according to an exemplary embodiment of the present invention generates a test signal during a test operation, and calculates and stores leakage parameters using a level difference of the test signal and a level difference of a test leakage signal. Then, during normal communication, the RFID reader compensates a leakage signal using the leakage parameters. Consequently, the RFID reader correctly recognizes a response signal transferred from the RFID tag, thereby improving the reliability of the RFID system.

### BRIEF DESCRIPTION OF THE DRAWINGS

Exemplary embodiments of the present invention will become apparent by reference to the following detailed description taken in conjunction with the accompanying drawings, wherein:

FIG. 1 is a block diagram of a radio frequency identification (RFID) system according to an exemplary embodiment of the present invention;

FIG. 2 is a block diagram of an RFID reader in FIG. 1;

FIG. 3 is a diagram illustrating a test signal of the RFID reader according to an exemplary embodiment of the present invention;

FIG. 4 is a diagram illustrating a test leakage signal according to the test signal in FIG. 3;

FIG. 5 is a flowchart illustrating a method of compensating a leakage signal according to an exemplary embodiment of the presenting invention;

FIG. 6 is a diagram illustrating an example of a return loss according to an antenna frequency;

FIG. 7 is a diagram illustrating another example of a return loss according to an antenna frequency;

FIG. 8 is a diagram illustrating a method of determining an amplitude and phase of a leakage signal using the return loss of the antenna in FIG. 7;

FIG. 9 is a diagram illustrating leakage parameters for controlling a leakage compensator in each channel; and

FIG. 10 is a flowchart illustrating a method of compensating a leakage signal according to an exemplary embodiment of the present invention.

### DETAILED DESCRIPTION OF EXEMPLARY EMBODIMENTS

Exemplary embodiments of the present invention seek to provide a radio frequency identification reader (RFID reader), which generates a test signal during a test operation, determines and stores leakage parameters using a level difference of the test signal and a level difference of a test leakage signal, and compensates a leakage signal using the leakage parameters during normal communication, and a method of compensating the leakage signal.

Exemplary embodiments of the present invention will be described herein with reference to the accompanying drawings.

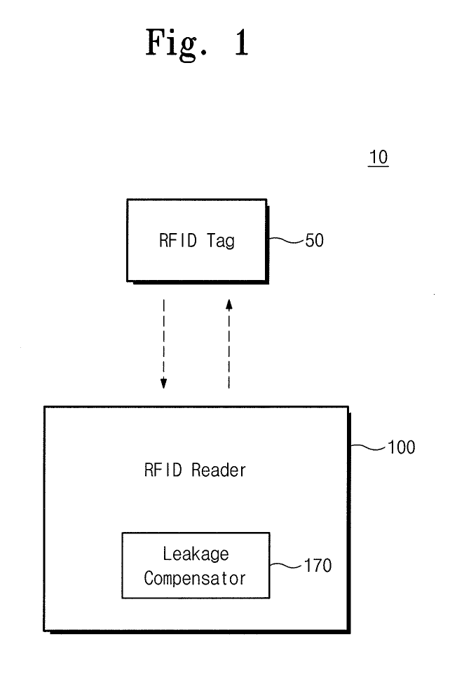

FIG. 1 is a block diagram of an RFID system 10 according to an exemplary embodiment of the present invention. Referring to FIG. 1, the RFID system 10 includes an RFID tag 50 and an RFID reader 100. The RFID tag 50 receives a transmission signal from the RFID reader 100. The RFID tag 50 modulates a continuous wave transferred from the RFID reader 100 to generate a response signal. The response signal is transferred to the RFID reader 100.

The RFID reader 100 transfers a transmission signal and a continuous wave to the RFID tag 50. The transmission signal is a signal for transmitting data to the RFID tag 50. The continuous wave is required for the RFID tag 50 to generate the response signal. The RFID reader 100 includes a leakage compensator 170 for compensating a leakage signal.

When the RFID reader 100 transmits a signal, a portion of the transmitted signal is transferred to a receiver of the RFID reader 100. The portion of the signal transmitted from the RFID reader 100 that is undesirably transferred to the receiver of the RFID reader 100 is called transmission leakage. A signal transferred to the receiver of the RFID reader 100 from a transmitter of the RFID reader 100 is called a leakage signal.

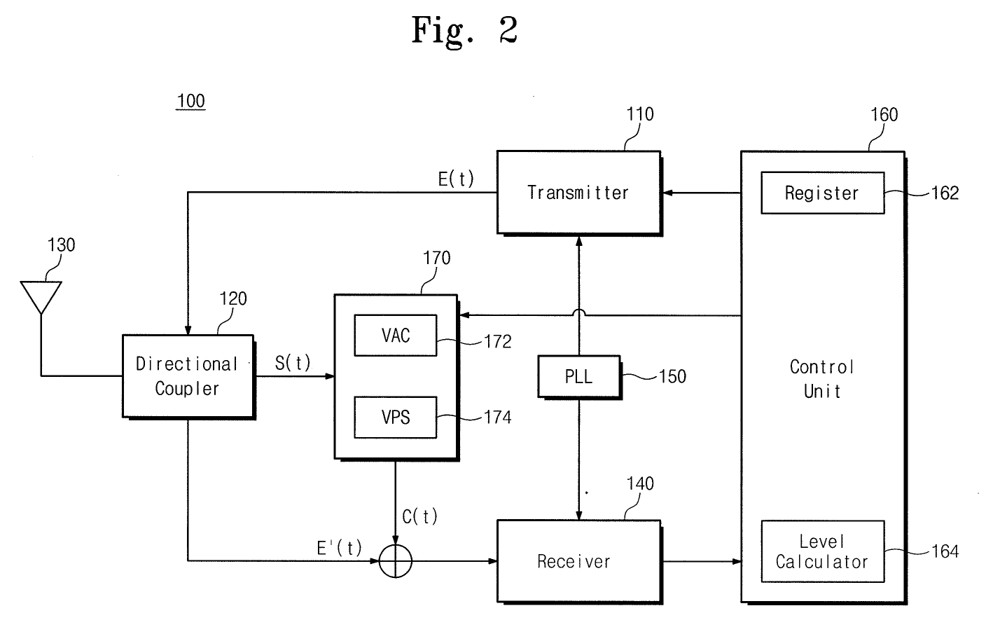

FIG. 2 is a block diagram of the RFID reader 100 of FIG. 1. Referring to FIG. 2, the RFID reader 100 includes a transmitter 110, a directional coupler 120, an antenna 130, a receiver 140, a phase locked loop (PLL) 150, a control unit 160, and a leakage compensator 170.

The transmitter 110 receives a signal to be transmitted to an RFID tag (not shown) from the control unit 160. The transmitter 110 modulates a signal transferred from the control unit 160 using a sinusoidal wave transferred from the PLL 150. The modulated signal (hereinafter, referred to as a transmission signal) is transmitted to the RFID tag through the directional coupler 120 and the antenna 130. The signal transferred from the control unit 160 and the sinusoidal wave transferred from the PLL 150 are composed of an in-phase channel (I-channel) and a quadrature phase channel (Q-channel), respectively. The I-channels of the sinusoidal wave and the signal transferred from the control unit 160, and the Q-channels of the sinusoidal wave and the signal transferred from the control unit 160 are mixed in a mixer (not shown) of the transmitter 110, respectively.

The directional coupler 120 transmits the transmission signal transferred from the transmitter 110 to the RFID tag through the antenna 130, and prevents the transmission signal from being transferred to the receiver 140. Also, the directional coupler 120 transfers the response signal transferred from the RFID tag through the antenna 130 to the receiver 140, and prevents the response signal from being transferred to the transmitter 110. Therefore, the directional coupler 120 isolates a transmitting path from a receiving path, and prevents interference or leakage of a signal between the transmitting and receiving paths. This property of the directional coupler is called isolation. However, a transmission/reception isolation provided by the directional coupler 120 is not perfect. Therefore, a portion of the transmission signal transferred from the transmitter 110 is transferred to the receiver 140 through the directional coupler 120.

The directional coupler 120 samples a portion of the transmission signal producing a sample signal. The sample signal is equal in frequency to the transmission signal. An amplitude ratio between the sample signal and the transmission signal and a phase difference between the sample signal and the transmission signal are controllable values. For example, the sample signal is controlled such that the sample signal generated from the directional coupler 120 has 1/100 times the amplitude of the transmission signal, and the phase of the sample signal is delayed by 45° with respect to the phase of the transmission signal.

The antenna 130 transfers the transmission signal, which is transferred from the transmitter 110 through the directional coupler 120, to the RFID tag, and transfers the response signal transferred from the RFID tag to the receiver 140 through the directional coupler 120. A portion of the signal transferred to the antenna 130 through the directional coupler 120 may be reflected back toward the directional coupler 120. Since the reflected signal is transferred to the directional coupler 120 from the antenna 130, the directional coupler 120 transfers the reflected signal to the receiver 140.

The receiver 140 receives the response signal transmitted from the RFID tag through the antenna 130 and the directional coupler 120. The receiver 140 demodulates the response signal transferred from the RFID tag using a sinusoidal wave transferred from the PLL 150. The modulated response signal is transmitted to the control unit 160. The signal transferred to the control unit 160 and the sinusoidal wave transferred from the PLL 150 are composed of an I-channel and a Q-channel, respectively. The I-channels of the sinusoidal wave and the signal transferred to the control unit 160, and the Q-channels of the sinusoidal wave and the signal transferred to the control unit 160 are mixed in a mixer (not shown) of the receiver 140, respectively.

The PLL 150 generates a sinusoidal wave with a fixed frequency. The sinusoidal wave generated from the PLL 150 is transferred to the receiver 110 and the transmitter 140. The frequency of the sinusoidal wave transferred to the transmitter 110 is equal to the sinusoidal wave transferred to the receiver 140. The signal transferred to the transmitter 110 and the signal transferred to the receiver 140 are composed of an I-channel and a Q-channel, respectively.

The control unit 160 applies a communication signal to the transmitter 110, and receives the response signal of the RFID tag from the receiver 140. During a leakage test operation, the control unit 160 applies a test signal to the transmitter 110. The leakage test operation is performed when the RFID reader 100 is in a non-communication state because it is impossible to measure a leakage signal if the response signal of the RFID tag is transferred to the receiver 140 during the leakage test operation. The control unit 160 measures the leakage signal transferred to the receiver 140, and determines leakage parameters according to the measured result. The control unit 160 stores the leakage parameters. During normal communication, the control unit 160 generates a leakage control signal according to a leakage parameter. The leakage control signal is transferred to a leakage compensator 170.

The control unit 160 includes a register 162, and a level calculator 164. The leakage parameters are stored in the register 162. The control unit 160 generates the leakage control signal according to the leakage parameters stored in the register 162 when the RFID reader communicates with the RFID tag. The level calculator 164 calculates a level difference between the test signal and the leakage signal.

The leakage compensator 170 receives the sample signal from the directional coupler 120. The leakage compensator 170 generates a leakage compensation signal in response to the leakage control signal transferred from the control unit 160. The leakage compensator 170 includes a variable amplitude controller 172, and a variable phase shifter 174. The variable amplitude controller 172 controls the amplitude of the sample signal in response to the leakage control signal transferred from the control unit 160. The variable phase shifter 174 shifts the phase of the sample signal in response to the leakage control signal transferred from the control unit 160.

During normal communication, the directional coupler 120 transfers the transmission signal to the antenna 130 when the transmission signal is transferred to the directional coupler 120 from the transmitter 110. Here, a portion of the transmission signal may be transferred to the receiver 140, that is, transmission leakage may occur. If the transmission leakage occurs, the leakage signal is transferred to the receiver 140. The RFID tag, which has received the transmission signal, transmits the response signal toward the RFID reader 100. The response signal is transferred to the receiver 140 through the antenna 130 and the directional coupler 120. That is, the mixed signal of the leakage signal and the response signal transferred from the RFID tag is transferred to the receiver 140. If the leakage compensation signal and the leakage signal have the same amplitude and have a phase difference of 180° therebetween, the leakage compensation signal offsets the leakage signal. That is, it is possible to compensate the transmission leakage by the use of the leakage compensation signal if the amplitude and phase of the leakage signal are known.

To measure the amplitude and phase of the leakage signal, the RFID reader 100 according to an exemplary embodiment of the present invention performs the leakage test operation. The leakage test operation is performed when the RFID reader 100 is in a non-communication state.

To start, when the control unit 160 applies the test signal to the transmitter 110, the transmitter 110 modulates the test signal and transmits a test transmission signal. The test transmission signal (E(t)) is defined in Equation (1).

E(t)=A(t)e^{jwt} (1)

where w is a frequency of the sinusoidal wave transferred from the PLL 150, and A(t) is a test signal.

In an exemplary embodiment of the present invention, the frequency (w) of the test transmission signal (E(t)) is fixed, whereas the amplitude (A(t)) of the test transmission signal (E(t)) varies with time. That is, the transmitter 110 receives the test signal (A(t)) to perform amplitude shift keying (ASK) modulation.

In the directional coupler 120, a portion of the test transmission signal (E(t)) is transmitted to the outside through the antenna 130, another portion is transferred to the receiver 140 to form a leakage signal, and yet another portion is sampled to form a sample signal (S(t)). Hereinafter, the leakage signal formed by the test transmission signal (E(t)) is referred to as a test transmission leakage signal (E′(t)). The sample signal (S(t)) is defined in Equation (2), and the test transmission leakage signal (E′(t)) is defined in Equation (3).

S(t)=K_{S}E(t)e^{jp}^{ₛ} (2)

where K_{S} is an amplitude ratio between the test transmission signal (E(t)) and the sample signal (S(t)), and P_{S} is a phase difference between the test transmission signal (E(t)) and the sample signal (S(t)). The sample signal (S(t)) is equal in frequency to the test transmission signal (E(t)). The amplitude ratio (K_{S}) between the transmission signal (E(t)) and the sample signal (S(t)), and the phase difference (P_{S}) between the transmission signal (E(t)) and the sample signal (S(t)) are controllable values.

E′(t)=Kₗ(t)e^{jp}^{ₗ}^{(t)}E(t) (3)

where Kₗ is an amplitude ratio between the test transmission signal (E(t)) and the test transmission leakage signal (E′(t)), and Pₗ is a phase difference between the test transmission signal (E(t)) and the test transmission leakage signal (E′(t)). The test transmission leakage signal (E′(t)) is equal in frequency to the test transmission signal (E(t)).

The leakage compensator converts the sample signal (S(t)) to generate a compensation signal (C(t)) in response to a leakage control signal. The compensation signal (C(t)) is defined in Equation (4).

C(t)=xₘ(t)e^{jx}^{ₚ}^{(t)}S(t) (4)

where xₘ(t) is a function representing an amount of change in amplitude of the sample signal (S(t)) in response to the leakage control signal, and xₚ(t) is a function representing an amount of change in phase of the sample signal (S(t)) in response to the leakage control signal. The compensation signal (C(t)) is equal in frequency to the sample signal (S(t)).

Through the combination of Equations (3) and (4), the compensation signal (C(t)) is expressed as Equation (5).

C(t)=xₘ(t)K_{S}e^{j(x}^{ₚ}^{(t)+P}^{_{S}}⁾E(t) (5)

The test transmission leakage signal (E′(t)) is offset when the compensation signal (C(t)) is equal in amplitude to the test transmission leakage signal (E′(t)), and a phase of the compensation signal is delayed by 180° with respect to a phase of the test transmission leakage signal (E′(t)). Therefore, the compensation signal (C(t)) is expressed as Equation (6).

C(t)=xₘ(t)K_{S}e^{j(x}^{ₚ}^{(t)+P}^{_{S}}⁾E(t)=−Kₗ(t)e^{jp}^{ₗ}^{(t)}E(t)=−E′(t) (6)

The function xₘ(t) is expressed as Equation (7) if summarizing Equation (6).

$${x}_{m} ( t ) = \frac{{K}_{l} ( t )}{{K}_{S}} \qquad ( 7 )$$

The function xₚ(t) is expressed as Equation (8) if summarizing Equation (6).

xₚ(t)=Pₗ(t)−P_{S}+π (8)

In Equations (7) and (8), the constants K_{S} and P_{S} are controllable values. Therefore, the compensation signal (C(t)) is determined when the amplitude ratio between the test transmission signal (E(t)) and the test transmission signal (E′(t)), and the phase difference between the test transmission signal (E(t)) and the test transmission leakage signal (E′(t)) are measured. It is possible to compensate the test transmission leakage signal through the compensation signal (C(t)).

In other words, the leakage signal is transferred to the receiver 140 when the transmitter transmits the transmission signal. The leakage signal is equal in frequency to the transmission signal, however, the leakage signal differs in amplitude and phase from the transmission signal. If the amplitude and phase of the transmission signal are compensated, it is possible to generate the leakage compensation signal which has the same amplitude as the leakage signal and has its phase delayed by 180° with respect to the leakage signal. The amplitude or phase of the leakage signal, or the amplitude ratio and phase difference between the transmission signal and the leakage signal should be measured in order to generate the leakage compensation signal by compensating the transmission signal.

In the RFID reader 100, the transmission leakage occurs when the response signal is transferred from the RFID tag. While the RFID tag transmits the response signal, the RFID reader transmits the continuous wave to the RFID tag. A mixed signal, in which the response signal transferred from the RFID tag and the leakage signal according to the continuous wave transferred from the transmitter 110 are mixed, is transferred to the receiver 140 of the RFID reader 100. If the amplitude and phase of the leakage signal according to the continuous wave are measured, or if the amplitude ratio and the phase difference between the continuous wave and the leakage signal according to the continuous wave are measured, the leakage compensation signal can be determined according to Equations (7) and (8).

However, it is difficult to accurately measure the amplitude and phase of the test leakage signal according to a continuous wave using the continuous wave as the test signal. This is because a voltage fluctuation of low frequency occurs in the test leakage signal due to a DC offset arising in the mixer of the receiver 140 and a coupling capacitance in the receiver 140. For example, the test leakage signal is mixed with the sinusoidal wave transferred from the PLL 150 in the mixer of the receiver 140. At this time, a portion of the sinusoidal wave may be leaked to a receiving terminal, and then mixed with the test leakage signal. When the leaked sinusoidal wave is demodulated in the mixer of the receiver 140, it is converted to a DC voltage. Further, the sinusoidal wave generated from the PLL 150 includes not only a sinusoidal wave with a frequency required by the RFID reader 100, but also sinusoidal waves with peripheral frequencies around the frequency required by the RFID reader 100. If the sinusoidal wave with the peripheral frequency is demodulated in the mixer of the receiver 140, a voltage fluctuation of low frequency appears. Such a phenomenon is called DC fluctuation.

The test signal has a constant amplitude and phase, whereas the test leakage signal transferred to the receiver 140 has an amplitude and phase that vary with time. In addition, the center of the amplitude of the test leakage signal also varies with time. Accordingly, the amplitude and the phase of the leakage signal measured using the continuous wave as the test signal may not be accurate.

To accurately measure the amplitude and phase of the leakage signal, the RFID reader 100 according to an exemplary embodiment of the present invention uses a test signal in which one cycle has a high-level section in which a level is higher than a reference level, and a low-level section in which a level is lower than the reference level. The transmission leakage is measured according to level differences between high and low levels of the test leakage signal and the test signal. When the DC fluctuation takes place, a change in a difference between the high level and the low level is small although the amplitude of the test leakage signal and the center of the amplitude are varied. This is because the DC fluctuation is a low-frequency voltage fluctuation. The DC fluctuation allows one cycle of the test leakage signal to rise or fall as a whole. That is, a change in a difference between the high level and the low level is small although the amplitude of the test leakage signal and the center of the amplitude are varied.

The RFID reader 100 according to the present invention uses a test signal having a plurality of cycles, wherein one cycle has the high-level section and the low-level section. The RFID reader 100 calculates a level difference between the high and low levels of respective cycles, and averages the calculated level differences of the respective cycles. The amplitude and phase of the test leakage signal are more accurately measured by using the test signal with the plurality of cycles.

The RFID reader 100 according to an exemplary embodiment of the present invention uses a square wave having a plurality of cycles as the test signal. In the square wave, one cycle has a high-level section and a low-level section. Further, a level difference between the high level and the low level is accurately calculated because a level difference between the high-level section and a low-level section is distinct.

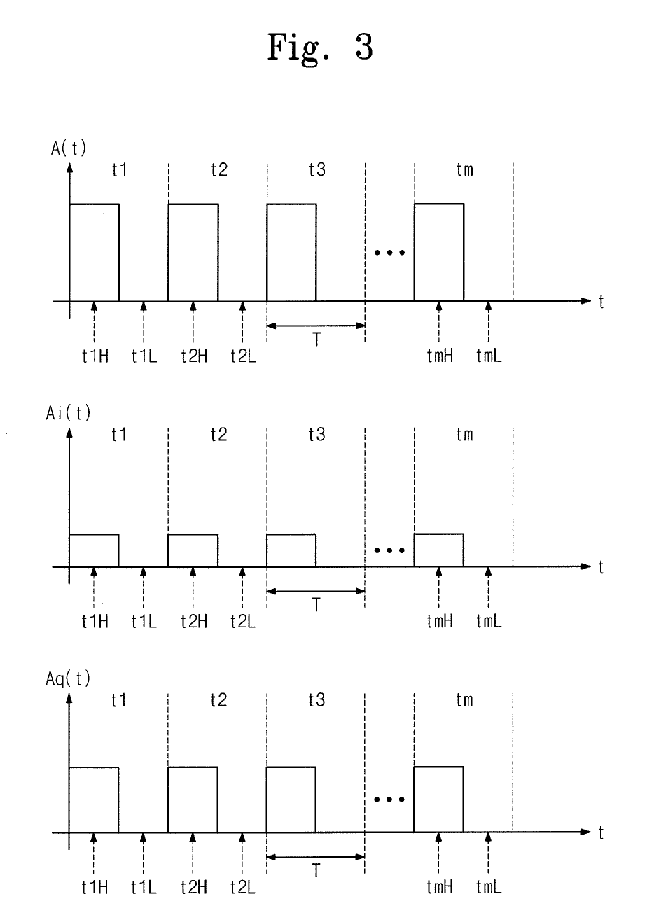

FIG. 3 is a diagram illustrating a test signal of the RFID reader according to an exemplary embodiment of the present invention. Referring to FIG. 3, the test signal (A(t)) is a square wave having a period of T. In FIG. 3, it is illustrated that the test signal (A(t)) has first to m-th cycles. The test signal (A(t)) is at high level during the first half section of a cycle, whereas the test signal (A(t)) is at low level during the second half section of the cycle.

The test signal (A(t)) includes an I-channel component and a Q-channel component. Hereinafter, the I-channel component of the test signal (A(t)) is defined as a test in-phase signal (Ai(t)), and the Q-channel component of the test signal (A(t)) is defined as a test quadrature phase signal (Aq(t)). FIG. 3 illustrates diagrams of the test in-phase signal (Ai(t)) and the test quadrature phase signal (Aq(t)). Since the test signal (A(t)) is a square wave, the test in-phase signal (Ai(t)) and the test quadrature phase signal (Aq(t)) are also square waves. Similarly to the test signal (A(t)), the test in-phase signal (Ai(t)) and the test quadrature phase signal (Aq(t)) have a period of T, and have first to mth cycles.

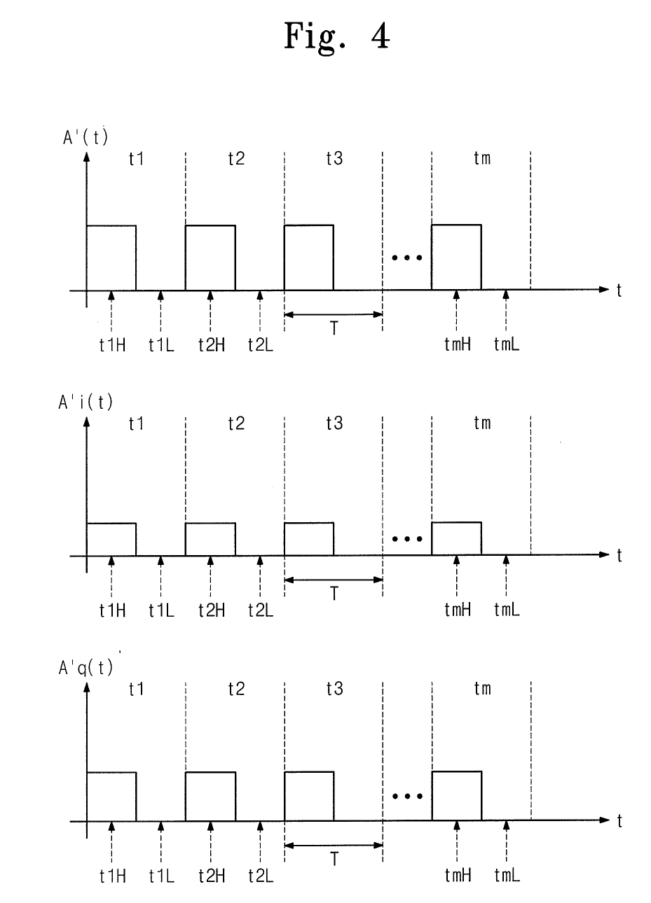

FIG. 4 is a diagram illustrating a test leakage signal according to the test signal in FIG. 3. In FIG. 4, it is illustrated that the test leakage signal (A′(t)) is a square wave. When the square wave is used as the test signal (A(t)), the test leakage signal (A′(t)) also has a waveform of a square wave having the same frequency as the test signal (A(t)). The test leakage signal (A′(t)) differs in amplitude and phase from the test signal (A(t)), but equals in frequency to the test signal (A(t)).

An actual test leakage signal (A′(t)) has a square waveform in which a square wave and a low-frequency signal are mixed. However, for the sake of clarity, description of an exemplary embodiment of the present invention will be provided assuming that the test leakage signal (A′(t)) is a square wave because a change in a level difference between the high level and the low level is not significant, as described above.

The test leakage signal (A′(t)) includes an I-channel component and a Q-channel component. Hereinafter, the I-channel component of the test leakage signal (A′(t)) is defined as a test leakage in-phase signal (A′i(t)), and the Q-channel component of the test leakage signal (A′(t)) is defined as a test leakage quadrature phase signal (A′q(t)). FIG. 4 illustrates diagrams of the test leakage in-phase signal (A′i(t)) and the test leakage quadrature phase signal (A′q(t)). Since the test leakage signal (A′(t)) is a square wave, the test leakage in-phase signal (A′i(t)) and the test leakage quadrature phase signal (A′q(t)) are also square waves. Similarly to the test leakage signal (A′(t)), the test leakage in-phase signal (A′i(t)) and the test leakage quadrature phase signal (A′q(t)) have a period of T, and have first to mth cycles.

In the case of a square wave such as the test signal (A(t)), a point at the end of the first quarter of a first cycle is defined as a first cycle high point t1H in the first cycle of the square wave. A point at the end of the first three quarters of the first cycle is defined as a first cycle low point t1L. Likewise, in second to m-th cycles of the square wave, time points at the end of the first quarter of respective cycles are defined as second to mth cycle high points t2H to tmH, and time points at the end of the first three quarters of the respective cycles are defined as second to m-th cycle low points t2L to tmL. Since the test signal (A(t)), the test in-phase signal (Ai(t)) and the test quadrature phase signal (Aq(t)) in FIG. 3 are square waves, there are high and low points in each cycle. Also, since the test leakage signal (A′(t)), the test leakage in-phase signal (A′i(t)) and the test leakage quadrature phase signal (A′q(t)) in FIG. 4 are square waves, there are high and low points in each cycle

For a clear and detailed explanation of an exemplary embodiment of the present invention, Equation (9) is defined below.

f(x(n))=x(tnH)−x(tnL) (9)

where tnH is an n-th cycle high point of a square wave (x(t)), and tnL is an nth cycle low point of the square wave (x(t)).

That is, Equation (9) is a function representing a level difference between high and low levels of a signal.

Equation (7) is a function representing the amplitude of the test leakage signal (A′(t)). Referring to Equation (7), the amplitude of the test leakage signal (A′(t)) is determined by an amplitude ratio between the test signal (A(t)) and the test leakage signal (A′(t)). Meanwhile, the ratio of the amplitude of the test signal (A(t)) to the amplitude of the test leakage signal (A′(t)) is equal to a ratio of a level difference between high and low levels of the test signal (A(t)) to a level difference between high and low levels of the test leakage signal (A′(t)). That is, the amplitude of the test leakage signal (A′(t)) may be defined as a ratio between a level difference of the test signal (A(t)) and a level difference of the test leakage signal (A′(t)). Equation (10) expresses the amplitude of the test leakage signal (A′(t)) using a ratio between the level difference of the test signal (A(t)) and the level difference of the test leakage signal (A′(t)).

$${x}_{m} ( t ) = \frac{\vert f ( {A}^{′} ( n ) ) \vert / f ( A ( n ) )}{{K}_{S}} \qquad ( 10 )$$

Equation (8) is a function representing a phase of the test leakage signal (A′(t)). An arc tangent of the level difference of the test leakage in-phase signal (A′i(t)) and the test leakage quadrature phase signal (A′q(t)) represents the phase of the test leakage signal (A′(t)). Therefore, the phase of the test leakage signal (A′(t)) is expressed as Equation (11).

$${x}_{p} ( t ) = {tan}^{- 1} ( \frac{f ( {A}^{′} q ( t ) )}{f ( {A}^{′} i ( t ) )} ) - {P}_{S} + π \qquad ( 11 )$$

When each of the test signal (A(t)) and the test leakage signal (A′(t)) has a plurality of cycles and a mean value of level differences of respective cycles is used, the amplitude of the test leakage signal (A′(t)) is measured by averaging the function f(x(n)). In addition, when each of the test signal (A(t)) and the test leakage signal (A′(t)) has a plurality of cycles and a mean value of level differences of respective cycles is used, the phase of the test leakage signal (A′(t)) is measured by averaging the function f(x(n)). If the amplitude and phase of the test leakage signal (A′(t)) are measured by Equations (10) and (11), the control unit 160 stores data of amplitude and phase in the register 162.

During normal communication, the control unit 160 transmits the transmission signal to the RFID tag through the transmitter 110, the directional coupler 120, and the antenna 130. When the continuous wave is transferred from the RFID reader 100, the RFID tag transmits the response signal. The control unit 160 transfers the leakage control signal to the leakage compensator 170. The leakage control signal is a signal having information indicating the amplitude and phase of the leakage signal. The leakage compensator 170 converts the sample signal (S(t)) to the leakage compensation signal (C(t)) in response to the leakage control signal. The leakage signal transferred to the receiver 140 is offset by the leakage compensation signal (C(t)), and transferred to the control unit 160 through the receiver 140. That is, the response signal, in which the leakage signal is compensated, is transferred to the control unit 160.

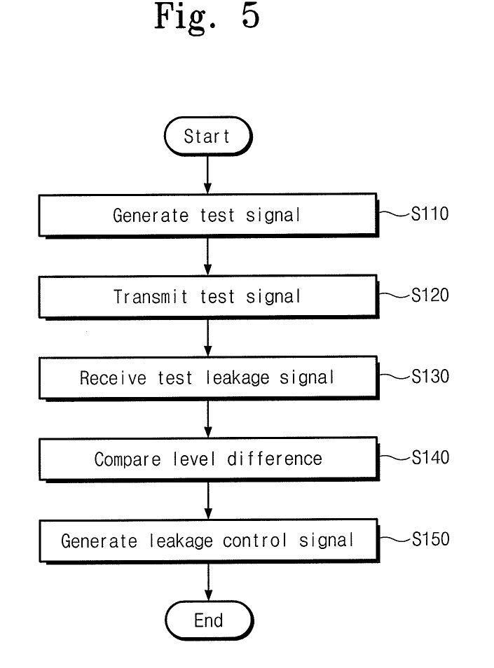

FIG. 5 is a flowchart illustrating a method of compensating a leakage according to an exemplary embodiment of the present invention. Referring to FIGS. 2 and 5, in operation S110, the control unit 160 controls the transmitter 110 to generate the test signal (A(t)). One cycle of the test signal (A(t)) has a high-level section in which a level is higher than a reference level, and a low-level section in which a level is lower than the reference level. To measure the leakage more accurately, the test signal (A(t)) has a plurality of cycles. For example, the test signal (A(t)) has a square waveform. A level difference between the high and low levels of the test signal (A(t)) is stored in the register 162.

In operation S120, the test signal (A(t)) is transmitted. In the directional coupler 120, a portion of the test signal (A(t)) is leaked to the receiver 140, and the other portion is transferred to the antenna 130. A portion of the test signal (A(t)) is reflected toward the directional coupler 120 from the antenna 130. The directional coupler 120 transfers the reflected signal to the receiver 140 because the reflected signal is transferred from the antenna 130.

In operation S130, the receiver 140 receives the test leakage signal (A′(t)). The test leakage signal (A′(t)) includes the signal leaked in the directional coupler 120, and the signal reflected from the antenna 130.

In operation S140, the level calculator 164 calculates a level difference of the test leakage signal (A′(t)). The control unit 160 calculates the amplitude and phase of the test leakage signal (A′(t)) according to the level difference of the test signal (A(t)), the level difference of the test leakage signal (A′(t)), and Equations (10) and (11). The calculation result is stored in the register 162 as a leakage parameter.

In operation S150, the control unit 160 generates the leakage control signal according to the leakage parameter. During a communicating operation, the control unit 160 transfers the leakage control signal to the compensator 170. The compensator 170 converts the sample signal (S(t)) to the leakage compensation signal (C(t)) in response to the leakage control signal. The variable amplitude controller 172 controls the amplitude of the sample signal (S(t)) such that the leakage compensation signal (C(t)) is equal in amplitude to the leakage signal. The variable phase shifter 174 shifts the phase of the sample signal (S(t)) such that the phase of the leakage compensation signal (C(t)) is delayed by 180° with respect to the phase of the leakage signal. The leakage compensation signal (C(t)) offsets the leakage signal, and the response signal transferred from the RFID tag is transferred to the control unit 160 through the receiver 140.

The RFID reader transmits a transmission signal in a frequency-hopping manner so as to communicate with a plurality of RFID tags using a limited frequency band. For example, in the Republic of Korea, the RFID system uses a frequency of 200 kHz for each channel in a frequency band of 908.5 MHz to 915 MHz. The RFID system in the Republic of Korea uses 27 channels. When a channel for transmitting a transmission signal is in use by another adjacent RFID reader, the RFID reader hops from one frequency to another frequency, and thus uses another channel. When a frequency of the transmission signal is changed, a frequency of a sinusoidal wave transmitted to the RFID tag is also changed. The antenna has a return loss that varies depending on a frequency. The return loss represents a ratio of the reflected signal to an input signal. The sinusoidal wave transmitted from the RFID reader is reflected from the antenna at different ratios according to frequencies. That is, the leakage signal, which is reflected from the antenna and transferred to the receiver, is changed.

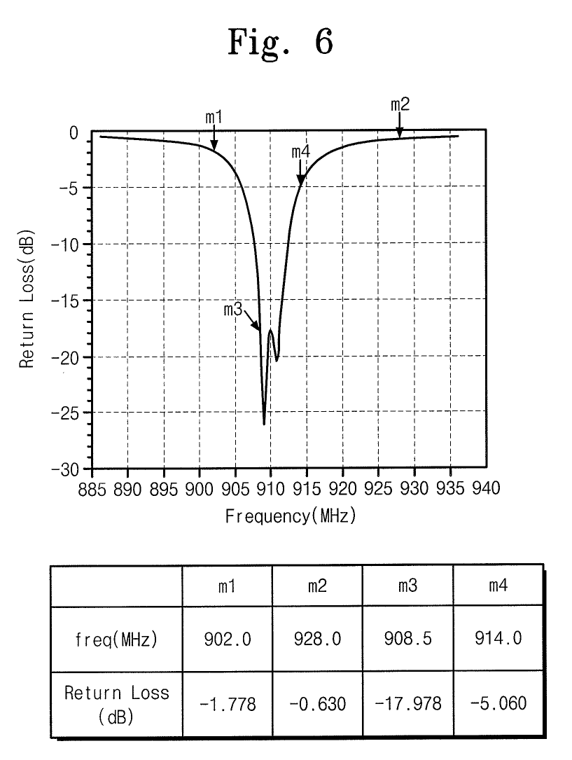

FIG. 6 is a diagram illustrating an example of a return loss according to an antenna frequency. Referring to FIG. 6, the horizontal axis indicates a frequency in units of mega hertz (MHz), and the vertical axis indicates a return loss in decibels (dB). A frequency of a first point (m1) is 902.0 MHz, and a return loss of the first point (m1) is −1.778 dB. A frequency of a second point (m2) is 928.0 MHz, and a return loss of the second point (m2) is −0.630 dB. A frequency of a third point (m3) is 908.5 MHz, and a return loss of the third point (m3) is −17.978 dB. A frequency of a fourth point (m4) is 914.0 MHz, and a return loss of the fourth point (m4) is −5.060 dB. The return losses of the first to fourth points (m1 to m4) differ from each other. In order for the RFID reader that has communicated with the tag using the frequency (902.0 MHz) of the first point (m1) to communicate with the tag using the frequency (908.5 MHz) of the third point (m3), the RFID reader needs to determine the leakage signal and the compensation signal again. This may lead to a decrease in a communication speed of the RFID system.

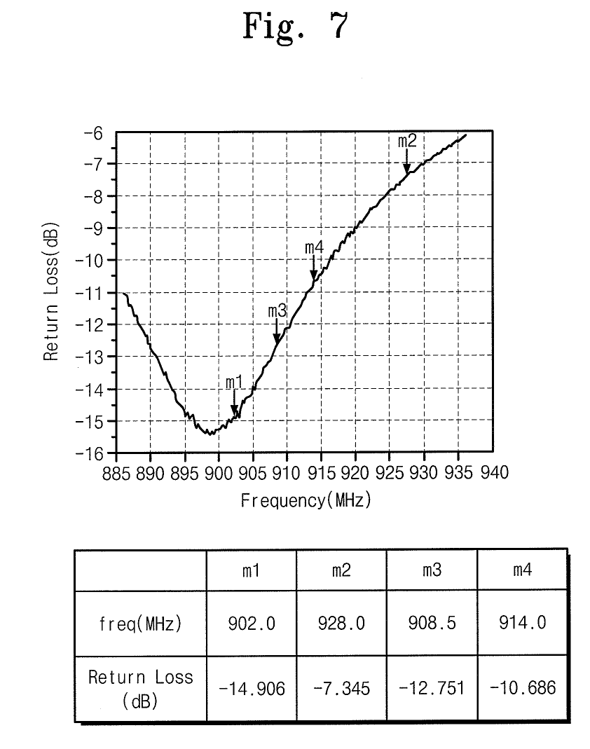

FIG. 7 is a diagram illustrating another example of a return loss according to an antenna frequency. Referring to FIG. 7, the horizontal axis indicates a frequency MHz, and the vertical axis indicates a return loss in dB. A frequency of a first point (m1) is 902.0 MHz, and a return loss of the first point (m1) is −14.906 dB. A frequency of a second point (m2) is 928.0 MHz, and a return loss of the second point (m2) is −7.345 dB. A frequency of a third point (m3) is 908.5 MHz, and a return loss of the third point (m3) is −12.751 dB. A frequency of a fourth point (m4) is 914.0 MHz, and a return loss of the fourth point (m4) is −10.686 dB. The return losses of the first to fourth points (m1 to m4) differ from each other. In order for the RFID reader that has communicated with the tag using the frequency (902.0 MHz) of the first point (m1) to communicate with the tag by the use of frequency (908.5 MHz) of the third point (m3), the RFID reader needs to determine the leakage signal and the compensation signal again. This may lead to a decrease in a communication speed of the RFID system.

When a transmission signal with a fixed frequency is transferred, the return loss of the antenna is constant. The return loss of the antenna corresponding to each frequency is measurable. When the return loss of the antenna is measured, the amplitude and phase of the leakage signal reflected from the antenna are determined. By the use of the amplitude and phase of the leakage signal, it is possible to compensate the leakage signal.

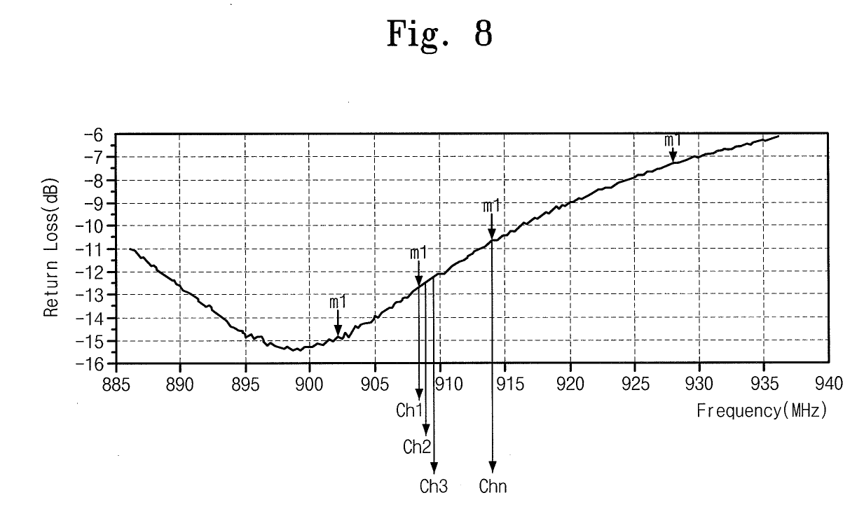

FIG. 8 is a diagram illustrating a method of determining the amplitude and phase of the leakage signal using the return loss of the antenna in FIG. 7. Referring to FIG. 8, the horizontal axis indicates a frequency in units of MHz, and the vertical axis indicates a return loss in dB. First to fourth points (m1 to m4) of FIG. 8 are equal to the first to fourth points (m1 to m4) of FIG. 7.

Referring to FIG. 8, for purposes of illustration in the Republic of Korea, the RFID system uses a frequency band of 908.5 MHz to 915 MHz and 27 channels. A frequency band of 200 kHz is assigned to each channel. The frequency of the third point (m3) is 908.5 MHz. The third point (m3) is assigned to a first channel. Channels are assigned at every 200 kHz starting from the third point (m3). The frequency of the fourth point (m4) is 914.0 MHz, and the fourth point (m4) is assigned to an nth channel.

The test signal is supplied to the antenna, the test leakage signal reflected from the antenna is received, and the return loss of the antenna is measured using the test signal and the test leakage signal. Return losses corresponding to respective channels are measured using the test signal with a frequency corresponding to each channel. The amplitudes and phases of the leakage signal corresponding to each channel may be determined according to the return losses. From the amplitudes and phases of the leakage signal, the amplitudes and phases of the compensation signal for compensating the leakage signal may be determined. The amplitudes and phases of the compensation signal are normalized to form leakage parameters for compensating the leakage signal.

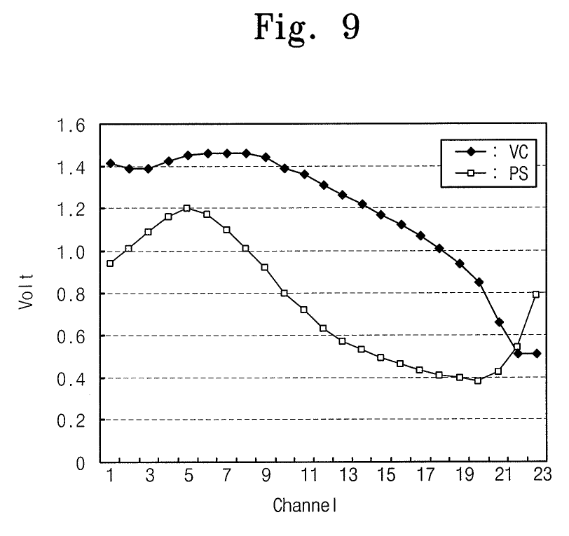

FIG. 9 is a diagram illustrating leakage parameters corresponding to each channel. Referring to FIG. 9, the horizontal axis indicates a channel, and the vertical axis indicates a voltage. Referring to FIGS. 2 and 9, the control unit 160 stores the leakage parameters corresponding to the respective channels in the register 162. During normal communication, when a transmission signal changes its frequency through frequency hopping, the control unit 160 generates the leakage control signal according to the leakage parameter corresponding to the selected channel.

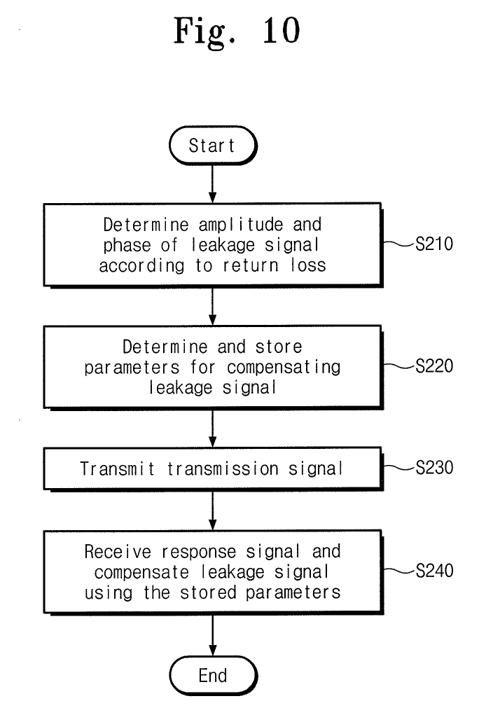

FIG. 10 is a flowchart illustrating a method of compensating a leakage signal according to the present invention. Referring to FIGS. 2 and 10, in operation S210, a return loss of the antenna 130 is measured. The test signal is supplied to the antenna 130, the test signal reflected from the antenna is received, and the return loss of the antenna 130 is measured using the test signal and the test leakage signal. Return losses corresponding to respective channels are measured using the test signal with a frequency corresponding to each channel. The return losses may be measured by the control unit 160. Alternatively, the return loss may be measured by a separate test device.

In operation S220, leakage parameters for compensating the leakage signal are determined and stored. The leakage parameters may be determined by the control unit 160. The leakage parameters may be stored in the register 162 of the control unit 160. The leakage parameters control the variable amplitude controller 172 and the variable phase shifter 174 to provide data for compensating the leakage signals corresponding to each channel.

In operation S230, the control unit 160 transmits a transmission signal through the transmitter 110. The transmission signal is transmitted in a frequency-hopping manner. The control unit 160 determines and selects an available channel among a number of channels. The control unit 160 controls the transmitter 110 in order for the transmission signal to have a frequency corresponding to the selected channel.

In operation S240, the receiver 140 receives the leakage signal and the response signal transferred from the RFID tag. The control unit 160 generates the leakage control signal according to a leakage parameter corresponding to the selected channel. The leakage control signal is transferred to the leakage compensator 170. The variable amplitude controller 172 and the variable phase shifter 174 generate the compensation signal which has the same amplitude as the leakage signal and has the phase delayed by 180° with respect to the phase of the leakage signal. The leakage compensator 170 compensates the leakage signal using the compensation signal.

In the aforementioned exemplary embodiments, the receiver and the transmitter of the RFID reader are connected to one antenna through the directional coupler. However, the receiver and the transmitter may be respectively connected to two antennas and the leakage compensation may be performed as described above.

In the aforementioned exemplary embodiments, the directional coupler connected to the antenna samples the transmission signal. However, the sampling of the transmission signal may be performed in a separate coupler connected to the transmission path.

In the aforementioned exemplary embodiments, the test signal does not have a phase offset. However, if the test signal has a phase offset, the amplitude and phase of the test leakage signal may be calculated in consideration of the phase offset when calculating the test leakage signal.

In at least one of the aforementioned exemplary embodiments, an RFID reader performs modulation and demodulation using amplitude shift keying (ASK), and modulation and demodulation of the test signal may be performed using phase shift keying (PSK).

The RFID reader generates a test signal during a test operation, and determines and stores leakage parameters using a level difference of the test signal and a level difference of a test leakage signal. Then, during normal communication, the RFID reader compensates a leakage signal using the leakage parameters.

Although exemplary embodiments of the present invention have been described for illustrative purposes, those skilled in the art will appreciate that various modifications, additions and substitutions are possible, without departing from the scope and spirit of the disclosure.

What is claimed is:

1. A radio frequency identification (RFID) reader, comprising:
a transmitter generating a transmission signal for transmission to a tag;
a receiver receiving a response signal from the tag;
a control unit applying a test signal to the transmitter to generate a test leakage signal, and generating a leakage control signal based on a difference of the test signal and the test leakage signal; and
a leakage compensator compensating signal leakage from the transmitter in response to the leakage control signal.

2. The RFID reader of claim 1, wherein the control unit further generates and stores a leakage parameter.

3. The RFID reader of claim 1, wherein the test signal is a square wave in which a cycle has a high-level section and a low-level section, the high-level section being higher than a reference level, and the low-level section being lower than the reference level.

4. The RFID reader of claim 3, wherein the test signal includes a plurality of cycles.

5. The RFID reader of claim 4, wherein the control unit calculates the leakage parameter using a mean value of a level difference of each cycle of the test leakage signal and a mean value of a level difference of each cycle of the test signal.

6. The RFID reader of claim 1, wherein the transmitter and the receiver are connected to a common antenna through a directional coupler.

7. The RFID reader of claim 1, wherein the transmitter comprises a transmitting antenna, and the receiver comprises a receiving antenna.

8. The RFID reader of claim 1, wherein the leakage compensator changes an amplitude and a phase of the transmission signal, and compensates the leakage signal using the changed transmission signal.

9. The RFID reader of claim 8, wherein the leakage parameter indicates an amplitude ratio between the transmission signal and the leakage signal, and a phase difference between the transmission signal and the leakage signal.

10. The RFID reader of claim 8, wherein the leakage compensator further comprises a variable amplitude controller controlling an amplitude of the transmission signal, and a variable phase shifter phase-shifting a phase of the transmission signal.

11. A method for compensating a leakage signal of an RFID reader including a transmitter generating a transmission signal for transmission to a tag, a receiver receiving a response signal from the tag, and a leakage compensator compensating a leakage signal leaked from the transmitter to the receiver,
the method comprising:
applying a test signal to the transmitter, and calculating and storing a leakage parameter using a level difference of the test signal and a level difference of a test leakage signal leaked to the receiver; and
compensating the leakage signal using the leakage parameter.

12. The method of claim 11, wherein the leakage parameter is stored in a register.

13. The method of claim 11, wherein the test signal is a square wave in which a cycle has a high-level section and a low-level section, the high-level section being higher than a reference level, and the low-level section being lower than the reference level.

14. The method of claim 13, wherein the test signal includes a plurality of cycles.

15. The method of claim 14, wherein the leakage parameter is calculated using a mean value of a level difference of each cycle of the test leakage signal and a mean value of a level difference of each cycle of the test signal.

16. The method of claim 11, wherein the leakage compensator changes an amplitude and a phase of the transmission signal, and compensates the leakage signal using the changed transmission signal.

17. The method of claim 16, wherein the leakage parameter indicates an amplitude ratio between the transmission signal and the leakage signal, and a phase difference between the transmission signal and the leakage signal.

18. A method of compensating a leakage signal of an RFID reader,
the RFID reader comprising:
a transmitter selecting one of a plurality of channels, and transmitting a transmission signal to a tag through an antenna using the selected channel;
a receiver receiving a response signal corresponding to the transmission signal from the tag;
a leakage compensator responding to a leakage control signal to compensate the leakage signal reflected from the antenna and leaked to the receiver,
the method comprising:
applying a test signal corresponding to a frequency of each of the plurality of channels to the antenna, receiving a test leakage signal reflected from the antenna, measuring a return loss using the test signal and the test leakage signal, and calculating and storing leakage parameters corresponding to each of the plurality of channels using the return loss; and
generating the leakage control signal using the leakage parameters.

19. The method of claim 18, wherein the leakage parameters are stored in a register.

20. The method of claim 18, wherein the generating of the leakage control signal comprises:
transmitting the transmission signal using the selected channel;
receiving the response signal from the tag; and
generating the leakage control signal using the leakage parameter corresponding to the selected channel.
